(19) United States
(12) Patent Application Publication
(10) Pub. No.: US 2014/0064570 A1
(43) Pub. Date: Mar. 6, 2014

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Hidehiko Miyakoshi, Shizuoka-ken (JP)

(73) Assignee: TOSHIBA TEC KABUSHIKI KAISHA, Tokyo (JP)

(21) Appl. No.: 13/968,558

(22) Filed: Aug. 16, 2013

(30) Foreign Application Priority Data
Sep. 6, 2012 (JP) 2012-196400

(51) Int. Cl. G06K 9/00

(52) U.S. Cl. CPC G06K 9/00771
USPC 382/110

(57) ABSTRACT

In accordance with one embodiment, an information processing apparatus includes an area specification module configured to specify a sufficiency area meeting a specified temperature condition from a thermography representing the temperature distribution in an image capturing area, an extraction module configured to extract feature amount from a specified area in a captured image of the image capturing area based on the sufficiency area specified by the area specification module and an object recognition module configured to recognize an object contained in the captured image using the feature amount extracted by the extraction module.

### CROSS-REFERENCE TO RELATED APPLICATION

This application is based upon and claims the benefit of priority from Japanese Patent Application No. 2012-196400, filed Sep. 6, 2012, the entire contents of which are incorporated herein by reference.

### FIELD

Embodiments described herein relate to an information processing apparatus and an information processing method.

### BACKGROUND

There is a conventional technology which extracts the feature amount of an object such as color, color distribution, size and shape by capturing an image of the object and the like and compares the extracted feature amount with pre-prepared data (feature amount) for comparison to recognize the category of the object. Moreover, a system is proposed which applies the technology to recognizing a commodity such as vegetable or fruit to register the sales of the recognized commodity.

### BRIEF DESCRIPTION OF THE DRAWINGS

FIG. 1 is a perspective view illustrating external configurations of a checkout system according to a first embodiment;

FIG. 2 is a block diagram illustrating the hardware arrangement of a POS terminal and a commodity reading apparatus shown in FIG. 1;

FIG. 3 is a diagram schematically illustrating an example of data configurations of a PLU file shown in FIG. 2;

FIG. 4 is a diagram schematically illustrating an example of data configurations of an elimination area specification file shown in FIG. 2;

FIG. 5 is a diagram schematically illustrating an example of data configurations of a determination area specification file shown in FIG. 2;

FIG. 6 is a diagram schematically illustrating an example of data configurations of a commodity characteristic file shown in FIG. 2;

FIG. 7 is a block diagram illustrating functional components of the POS terminal and the commodity reading apparatus shown in FIG. 1;

FIG. 8 is a diagram illustrating a display example of the commodity candidate displayed on a display device of the commodity reading apparatus;

FIG. 9 is a flowchart illustrating the procedure of a commodity recognition processing executed by the commodity reading apparatus;

FIG. 10 is a flowchart illustrating the procedure of a sales registration processing executed by the POS terminal;

FIG. 11 is a perspective view illustrating configurations of a self POS according to a second embodiment; and

FIG. 12 is a block diagram illustrating the hardware arrangement of the self POS shown in FIG. 11.

### DETAILED DESCRIPTION

In accordance with a first embodiment, an information processing apparatus includes an area specification module, an extraction module and an object recognition module. The area specification module is configured to specify a sufficiency area meeting a specified temperature condition from a thermography representing the temperature distribution in an image capturing area. The extraction module is configured to extract feature amount from a specified area in a captured image of the image capturing area based on the sufficiency area specified by the area specification module. The object recognition module is configured to recognize an object contained in the captured image using the feature amount extracted by the extraction module.

Embodiments of the information processing apparatus and method are described in detail below with reference to accompanying drawings. In addition, the embodiments described below are embodiments of the information processing apparatus and method and are not presented to limit the configuration or specification of the information processing apparatus and method. The present embodiment is an application examples applied to a checkout system which is imported in a store such as a supermarket and comprises a POS terminal for registering and settling the commodities involved in one transaction and a commodity reading apparatus for reading the information relating to a commodity.

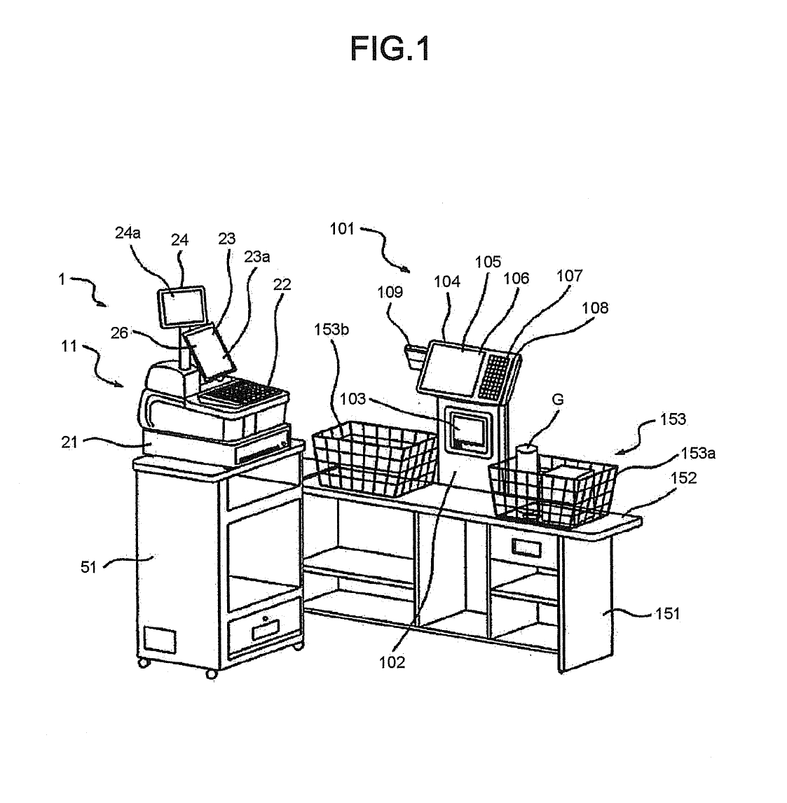

FIG. 1 is a perspective view illustrating external configurations of a checkout system 1. As shown in FIG. 1, the checkout system 1 comprises a POS terminal 11 and a commodity reading apparatus 101 serving as an information processing apparatus.

The POS terminal 11 is placed on the drawer 21 on a checkout counter 51. The drawer 21 is opened under the control of the POS terminal 11. A keyboard 22 is arranged on the upper surface of the POS terminal 11 for an operator (shop clerk) to operate. Seen from the operator operating the keyboard 22, a display device 23 for displaying information to the operator is arranged more rear than the keyboard 22. The display device 23 displays information on the display screen 23a thereof. A touch panel 26 is laminated on the display screen 23a. A display for customer 24 is vertically arranged to be capable of rotating freely at a position more rear than the display device 23. The display for customer 24 displays information on the display screen 24a thereof.

Moreover, the display screen 24a of the display for customer 24 is directed to the nearer side of the operator in FIG. 1, however, the display for customer 24 can be rotated such that the display screen 24a is directed to the rear side of FIG. 1, thereby displaying the information to a customer.

A horizontally long table-shaped counter table 151 is arranged to be in an L shape with the checkout counter 51 on which the POS terminal 11 is placed. A commodity receiving surface 152 is formed on the counter table 151. Shopping baskets 153 for storing commodity G are placed on the commodity receiving surface 152. It can be considered to classify the shopping baskets 153 into a first shopping basket 153a which is held by a customer and a second shopping basket 153b which is placed facing the first shopping basket 153a across a commodity reading apparatus 101.

The commodity reading apparatus 101, which is connected with the POS terminal 11 to be capable of carrying out data transmission/reception, is arranged on the commodity receiving surface 152 of the counter table 151. The commodity reading apparatus 101 has a thin rectangular housing 102.

A reading window 103 is arranged on the front side of the housing 102. A display and operation section 104 is arranged at the upper part of the housing 102. A display device 106 having a touch panel 105 laminated on the surface thereof is arranged on the display and operation section 104. A keyboard 107 is arranged on the right of the display device 106. A card reading slit 108 of a card reader (not shown) is arranged on the right of the keyboard 107. Seen from the side of an operator, a display for customer 109 is arranged at the left of the back side of the display and operation section 104 to provide information for a customer.

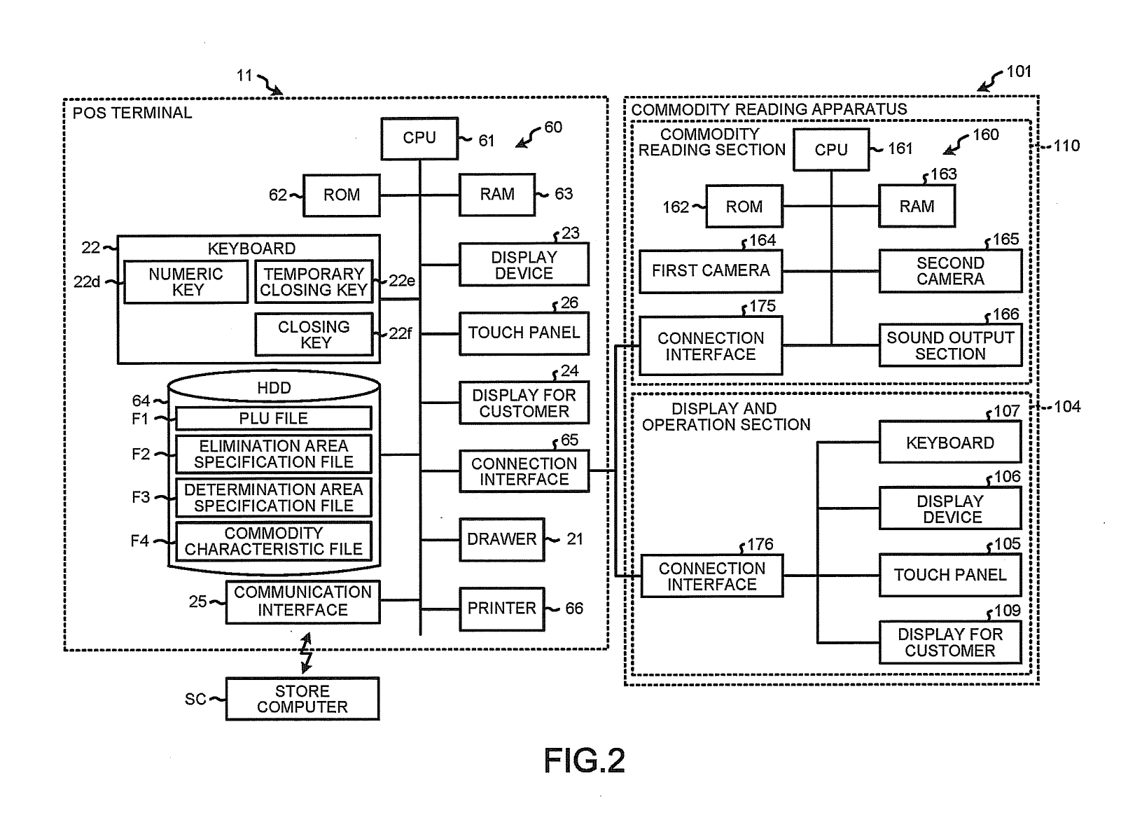

Such a commodity reading apparatus 101 comprises a commodity reading section 110 (referring to FIG. 2). In the commodity reading section 110, a first camera 164 and a second camera 165 (referring to FIG. 2) are arranged behind the reading window 103.

The commodity G involved in one transaction is stored in the first shopping basket 153a held by a customer. The commodity G in the first shopping basket 153a is moved to the second shopping basket 153b by the operator operating the commodity reading apparatus 101. When being moved, the commodity G is directed to the reading window 103 of the commodity reading apparatus 101. At this time, the first camera 164 and the second camera 165 (referring to FIG. 2) arranged in the reading window 103 capture the commodity G.

FIG. 2 is a block diagram illustrating the hardware arrangement of the POS terminal 11 and the commodity reading apparatus 101.

The POS terminal 11 comprises a microcomputer 60 serving as an information processing section for executing information processing. The microcomputer 60 is configured by connecting a CPU (Central Processing Unit) 61 which executes various arithmetic operations and controls each section with a ROM (Read Only Memory) 62 and a RAM (Random Access Memory) 63 via a bus line.

The drawer 21, the keyboard 22, the display device 23, the touch panel 26 and the display for customer 24 are all connected with the CPU 61 of the POS terminal 11 via various input/output circuits (not shown).

The keyboard 22 includes a numeric key 22d on which numeric characters such as ‘1’, ‘2’, ‘3’ . . . and operators such as multiplying operator ‘*’ are displayed, a temporary closing key 22e and a closing key 22f.

The CPU 61 of the POS terminal 11 is connected with an HDD (Hard Disk Drive) 64, in which various programs and files are stored. When the POS terminal 11 is started, the programs stored in the HDD 64 are all or partially copied to the RAM 63 and executed by the CPU 61 in sequence.

Further, data files such as a PLU file F1, an elimination area specification file F2, a determination area specification file F3 and a commodity characteristic file F4 and the like are stored in the HDD 64. Further, the PLU file F1, the elimination area specification file F2, the determination area specification file F3 and the commodity characteristic file F4 are held in a readable (referable) state from the commodity reading apparatus 101 via a connection interface 65 which will be described later.

The PLU file F1 is a data file in which the association between a commodity G sold in the store and the information relating to the sales registration of the commodity G is set.

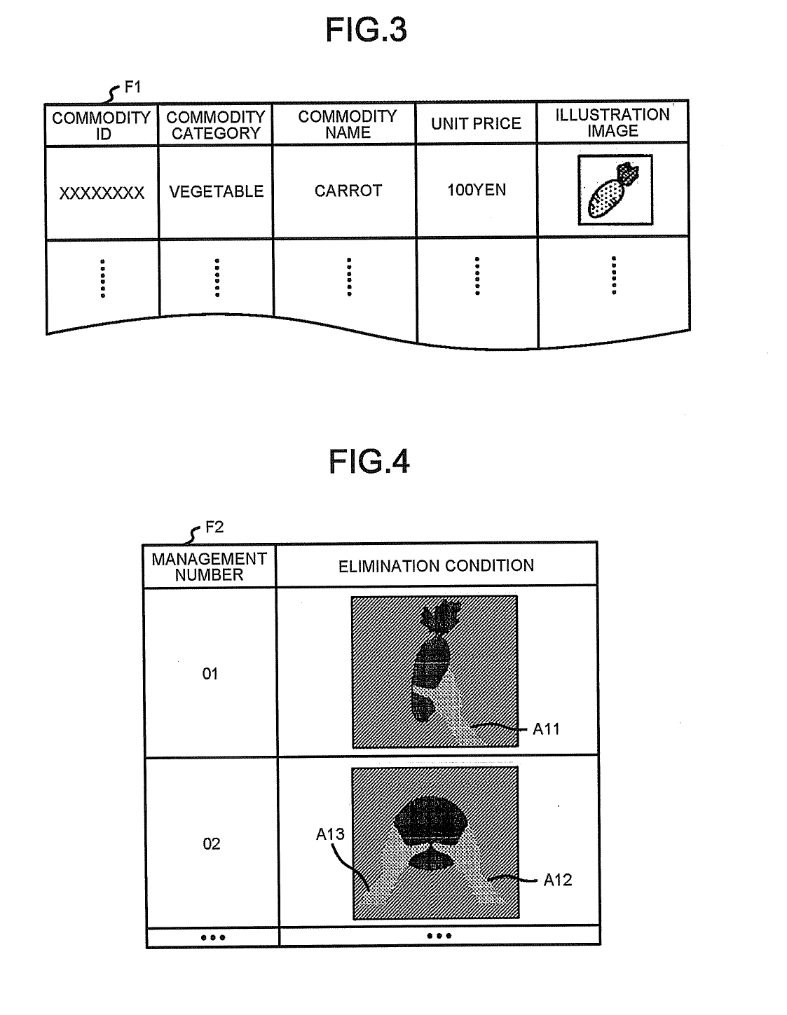

FIG. 3 is a diagram schematically illustrating an example of data configurations of the PLU file F1. As shown in FIG. 3, a commodity ID uniquely allotted to each commodity G, information relating to a commodity such as a commodity category to which the commodity G belongs, a commodity name and a unit price, and an illustration image representing the commodity are registered as commodity information of the commodity G in the FLU file F1. Hereinafter, the commodity G in association with a commodity ID is referred to as a registration commodity.

The elimination area specification file F2 is a data file storing a condition (hereinafter called as elimination condition) for specifying the area (elimination area) eliminated from the object subjected to feature amount extraction which will be described later in the image captured by the commodity reading apparatus 101.

FIG. 4 is a diagram schematically illustrating an example of data configurations of the elimination area specification file F2. As shown in FIG. 4, various elimination conditions relating to the specification of the elimination area are stored in the elimination area specification file F2 in association with a management number for identifying each elimination condition. In the elimination condition, for example, a specified temperature range, a shape of an area having the temperature range and an arrangement position of the area and the like may be defined.

Herein, the elimination condition of the management number “01” is an example of defining a state in which a person is holding an object such as a commodity G with one hand using the thermography captured by the first camera 164 which will be described later. In this example, an area A11 (an area in a hand shape) having the temperature range (34-40 degrees centigrade) of body temperature is set as a condition.

Further, the elimination condition of the management number “02” is an example of defining a state in which a person is holding an object such as a commodity G with two hands using the thermography captured by the first camera 164 which will be described later. In this example, areas A12, A13 (areas in a hand shape) having the temperature range of body temperature and the arrangement positions (for example, oppositely-arranged) of the areas A12, A13 are set as conditions.

In this way, conditions for specifying a reflection area of a hand and the like which is a hindrance to the recognition of the commodity G from the captured image captured when a shop clerk directs the commodity G to the reading window 103 are held in the elimination conditions of the elimination area specification file F2.

The determination area specification file F3 is a data file storing a condition (hereinafter referred to as determination condition) for specifying an area subjected to feature amount extraction (hereinafter referred to as determination area) in the image captured by the commodity reading apparatus 101.

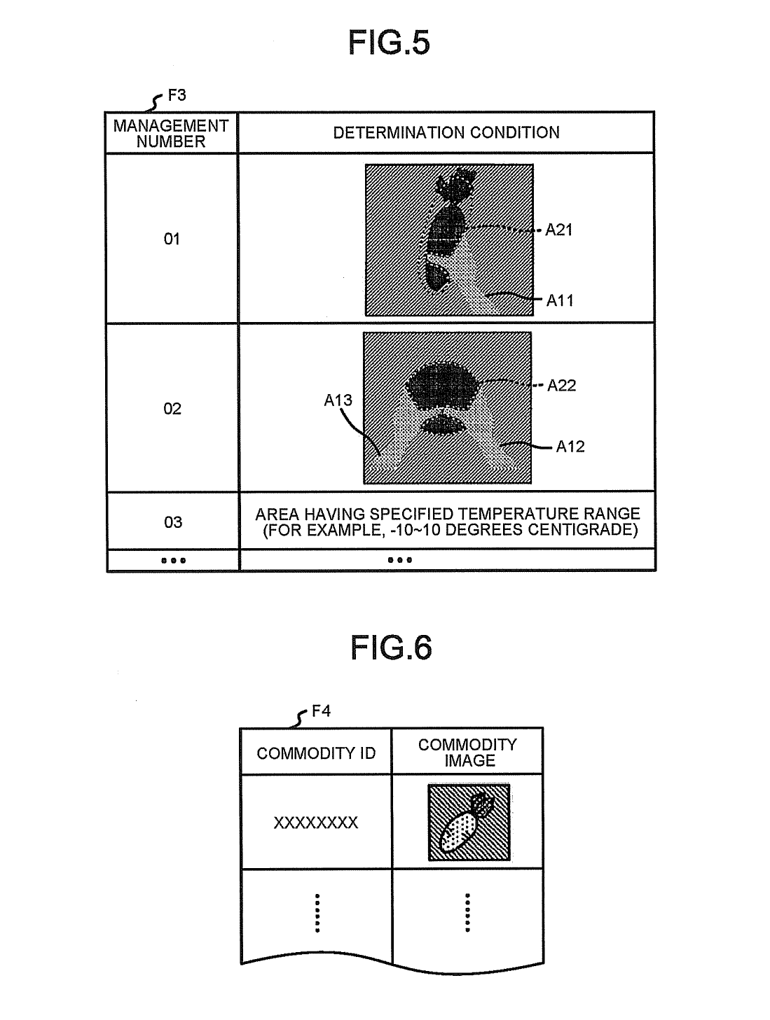

FIG. 5 is a diagram schematically illustrating an example of data configurations of the determination area specification file F3. Various determination conditions relating to the specification of the determination area are stored in the determination area specification file F3 in association with the management number. In the determination condition, the same as the elimination condition described above, for example, a specified temperature range, a shape of an area having the temperature range and an arrangement position of the area and the like may be defined.

Herein, the determination condition of the management number “01”, which is defined using the elimination condition of the management number “01” shown in FIG. 4, sets an area (referring to the area A21 in dotted line) adjacent to the area A11 in a hand shape having the temperature range of body temperature as a condition. In this case, it may be set that a direction in which the object is grabbed is determined according to the hand shape, and then the area A21 is defined according to the direction.

Further, the determination condition of the management number “02”, which is defined using the elimination condition of the management number “02” shown in FIG. 4, sets an area (referring to the area A22 in dotted line) between the areas A12 and A13 as a condition. In addition, the determination condition of the management number “03” sets an area having a specified temperature range such as a temperature range of refrigeration/freezing (for example, −10-10 degrees centigrade) as a condition.

In this way, conditions for specifying an area in which the commodity G subjected to the recognition exists from the captured image captured when a shop clerk directs the commodity G to the reading window 103 are held in the determination condition of the determination area specification file F3.

Further, an example of defining the elimination condition and the determination condition using the thermography is illustrated in one part of FIG. 4 and FIG. 5, but the invention is not limited to this, it may also be set that the conditions such as the shape, position relation, temperature distribution and the like of an area subjected to specification are defined using a feature amount (numeric parameter and the like) representing the state feature of the conditions or a relational expression and the like. In addition, it is set in FIG. 5 that the determination condition is defined with reference to the elimination area (elimination condition), but it is not limited, the determination condition may be independently defined without the elimination condition. Further, in the present embodiment, it is set that both conditions of the elimination condition and the determination condition are defined, however, it is not limited to this, it may also be set that any one of the elimination condition and the determination condition is defined.

Further, the elimination condition and the determination condition determined based on the image captured by the second camera 165 which will be described later may be stored in the elimination area specification file F2 or the determination area specification file F3. For example, the elimination condition which regards the flesh color area in the captured image as a reflection area of a hand (elimination area) may be defined. In addition, all or part of the outline of the commodity G sold in the store is stored separately in advance, and the determination condition which regards the area in the captured image which is substantially coincident with the outline as a reflection area (determination area) of a commodity directed to the reading window 103 may be defined.

Each commodity G sold in the store is stored in the commodity characteristic file F4 in association with the information representing the feature of the commodity G.

FIG. 6 is a diagram schematically illustrating an example of data configurations of the commodity characteristic file F4. As shown in FIG. 6, in the commodity characteristic file F4, the commodity ID of each commodity G is registered in association with a captured image (hereinafter referred to as commodity image) obtained by capturing the commodity G. Herein, the commodity ID is corresponding to the commodity ID registered in the PLU file F1. Further, the data configuration of the commodity characteristic file F4 is not limited to the example shown in FIG. 6, for example, it may be set that the feature amount such as the color, pattern, concave-convex situation, shape and the like of the commodity G read from the commodity image are registered instead of the commodity image.

Return to FIG. 2, a communication interface 25 for executing data communication with a store computer SC is connected with the CPU 61 of the POS terminal 11 via an input/output circuit (not shown). The store computer SC is arranged in the backyard and the like of a store. The PLU file F1 and the like distributed to the POS terminal 11 are stored in the HDD (not shown) of the store computer SC.

Further, the connection interface 65 capable of carrying out data transmission/reception with the commodity reading apparatus 101 is connected with the CPU 61 of the POS terminal 11. The commodity reading apparatus 101 is connected with the connection interface 65. Further, a printer 66 for printing on a receipt is connected with the CPU 61 of the POS terminal 11. The printer 66 prints the content of a transaction on a receipt under the control of the CPU 61.

On the other hand, the commodity reading apparatus 101, the same as the POS terminal 11, comprises a microcomputer 160. The microcomputer 160 is configured by connecting a CPU 161 with a ROM 162 which stores programs executed by the CPU 161 and a RAM 163 via the bus line.

The first camera 164, the second camera 165 and a sound output section (module) 166 are connected with the CPU 161 via various input/output circuits (not shown). The operations of the first camera 164, the second camera 165 and the sound output section 166 are controlled by the CPU 161. Further, an illumination section (not shown) for irradiating illumination light to the image capturing area of the first camera 164 and the second camera 165 is arranged at the rear side of the reading window 103.

The first camera 164 is a thermo camera using far-infrared ray. The first camera 164 carries out image capturing from the reading window 103 under the control of the CPU 161 and outputs the far-infrared ray irradiated from the captured object in the image capturing area, that is, the temperature distribution in the image capturing area, as a thermography. The second camera 165 is an image capturing apparatus including an image sensor such as a color CCD sensor or color CMOS sensor and the like. The second camera 165 carries out image capturing from the reading window 103 under the control of the CPU 161 and outputs the image obtained by image capturing as a captured image. In addition, the image capturing ranges of the first camera 164 and the second camera 165 are set to face the outside of the reading window 103 to capture the substantially same position.

The first camera 164 and the second camera 165 carry out image capturing at a specified frame rate, for example 30 fps. The captured image is stored in the RAM 163 sequentially. In addition, the image capturing timing of the first camera 164 and the second camera 165 is expected to be synchronous.

The sound output section 166 includes a sound circuit and a speaker for generating a preset alarm sound and the like. Under the control of the CPU 161, the sound output section 166 notifies by a sound such as an alarm sound and the like.

Further, the connection interface 175 which is connected with the connection interface 65 of the POS terminal 11 to be capable of carrying out data transmission/reception with the POS terminal 11 is connected with the CPU 161. Further, the display and operation section 104 is connected with the connection interface 175 via a connection interface 176, and the CPU 161 carries out data transmission/reception with the display and operation section 104 via the connection interface 175.

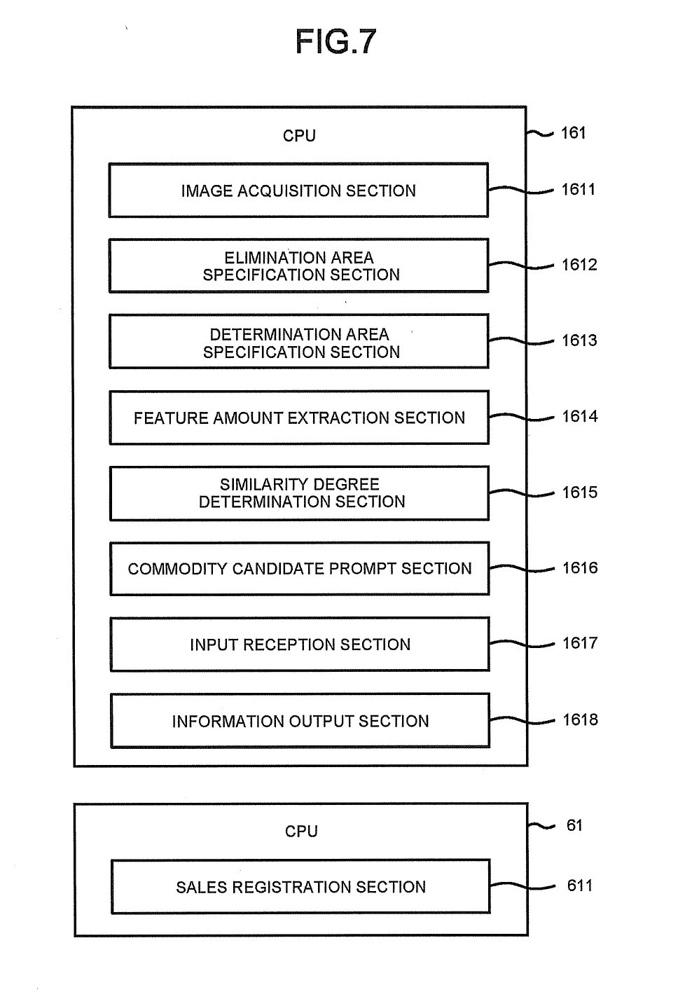

Next, the functional components of the CPU 161 and the CPU 61 realized by executing programs are described below with reference to FIG. 7.

FIG. 7 is a block diagram illustrating the functional components of the POS terminal 11 and the commodity reading apparatus 101. As shown in FIG. 7, by executing programs sequentially, the CPU 161 of the commodity reading apparatus 101 functions as an image acquisition section (module) 1611, an elimination area specification section (module) 1612, a determination area specification section (module) 1613, a feature amount extraction section (module) 1614, a similarity degree determination section (module) 1615, a commodity candidate prompt section (module) 1616, an input reception section (module) 1617 and an information output section (module) 1618.

The image acquisition section 1611 outputs an ON-signal of image capturing to the first camera 164 to activate the first camera 164 to start an image capturing operation, and acquires the thermography which is captured by the first camera 164 and stored in the RAM 163 in sequence. Further, the image acquisition section 1611 outputs an ON-signal of image capturing to the second camera 165 to activate the second camera 165 to start an image capturing operation, and acquires the captured image which is captured by the second camera 165 and stored in the RAM 163 in sequence. In addition, it is expected that the image acquisition section 1611 acquires the thermography and the captured image at the same timing.

The elimination area specification section 1612 specifies the elimination area from the thermography acquired by the image acquisition section 1611 according to the elimination condition stored in the elimination area specification file F2.

For example, in the case where the sufficiency area meeting the elimination condition (area A11) of the management number “01” shown in FIG. 4 exists in the thermography acquired by the image acquisition section 1611, the elimination area specification section 1612 specifies the sufficiency area as the elimination area. In addition, in the case where the sufficiency areas meeting the elimination condition (areas A12 and A13) of the management number “02” shown in FIG. 4 exist in the thermography acquired by the image acquisition section 1611, the elimination area specification section 1612 specifies these sufficiency areas as the elimination areas.

Further, in the case where the elimination condition based on the captured image of the second camera 165 is defined in the elimination area specification file F2, the elimination area specification section 1612 analyzes the captured image acquired by the image acquisition section 1611 and determines whether or not the sufficiency area meeting the elimination condition exists in the captured image.

In addition, the elimination area specification section 1612 is set to respectively determine the elimination condition stored in the elimination area specification file F2 in units of management number. However, it may also be set to determine using the compound elimination condition which is formed by logically combining the elimination conditions of a plurality of management numbers with “AND” or “OR”. Further, no specific limitation is given to the determination method of the thermography and captured image acquired by the image acquisition section 1611 and the elimination condition, for example, known technology such as pattern matching and object recognition technology which will be described later may be used.

The determination area specification section 1613 specifies the determination area from the captured image acquired by the image acquisition section 1611 according to the determination condition stored in the determination area specification file F3.

For example, in the case where the sufficiency area meeting the determination condition (area A21) of the management number “01” shown in FIG. 5 exists in the thermography acquired by the image acquisition section 1611, the determination area specification section 1613 specifies the sufficiency area as the determination area. In addition, in the case where the sufficiency area meeting the determination condition (area A22) of the management number “02” shown in FIG. 5 exists in the thermography acquired by the image acquisition section 1611, the determination area specification section 1613 specifies the sufficiency area as the determination area. In addition, in the case where the sufficiency area meeting the determination condition of the management number “03” shown in FIG. 5 exists in the thermography acquired by the image acquisition section 1611, the determination area specification section 1613 specifies the sufficiency area as the determination area.

Further, in the case where the elimination area is used in the determination of the determination condition as shown by the management numbers “01” and “02” in FIG. 5, the determination area specification section 1613 specifies the determination area using the specification result of the elimination area specification section 1612.

Further, in the case where the determination condition based on the captured image of the second camera 165 is defined in the determination area specification file F3, the determination area specification section 1613 analyzes the captured image acquired by the image acquisition section 1611 and determines whether or not the sufficiency area meeting the determination condition exists in the captured image.

In addition, the determination area specification section 1613 is set to respectively determine the determination condition stored in the determination area specification file F3 in units of management number. However, it may also be set to determine using the compound determination condition which is formed by logically combining the determination conditions of a plurality of management numbers with “AND” or “OR”. Further, no specific limitation is given to the determination method of the thermography and captured image acquired by the image acquisition section 1611 and the determination condition, for example, known technology such as pattern matching and object recognition technology which will be described later may be used.

The feature amount extraction section 1614 extracts the surface state (surface color, pattern, concave-convex situation, shape and the like) of the commodity G contained in the captured image from the captured image acquired by the image acquisition section 1611 based on the area specified by the elimination area specification section 1612 and the determination area specification section 1613.

Specifically, the feature amount extraction section 1614 eliminates the area in the captured image corresponding to the elimination area specified by the elimination area specification section 1612 from the object subjected to feature amount extraction. Further, the feature amount extraction section 1614 regards the area in the captured image corresponding to the determination area specified by the determination area specification section 1613 as an object subjected to feature amount extraction, and extracts feature amount from an image contained in the area.

Herein, the area subjected to feature amount extraction is the reflection area of the commodity G directed to the reading window 103. Thereby, the feature amount of the commodity G can be extracted efficiently and the precision can be improved, therefore the recognition rate of the commodity G by the similarity degree determination section 1615 which will be described later can be increased.

Further, in the elimination area and the determination area, if the elimination area is specified, the feature amount is extracted from the residual area after the elimination area is eliminated from the captured image; and if the determination area is specified, the feature amount is extracted from the determination area.

The similarity degree determination section 1615 compares the feature amount extracted by the feature amount extraction section 1614 with the feature amount of each registration commodity registered in the commodity characteristic file F4 of the POS terminal 11 and specifies the registration commodity (commodity ID) of which the similarity degree showing how much similar are the two feature amounts is above a specified threshold value from the commodity characteristic file F4.

Specifically, the similarity degree determination section 1615 respectively calculates the similarity degree between the commodity contained in the captured image and each registration commodity registered in the commodity characteristic file F4 by comparing the feature amounts and recognizes the registration commodity (commodity ID) of which the similarity degree is above a specified threshold value as a candidate of the commodity G captured by the second camera 165.

The recognition of an object contained in an image stated above is referred to as generic object recognition. As to the generic object recognition, various recognition technologies are described in the following document.

Keiji Yanai “The current state and future directions on generic object recognition”, Journal of Information Processing Society, Vol. 48, No. SIG16 [Search on Heisei 24 July 26], Internet <URL: http://mm.cs.uec.ac.jp/IPSJ-TCVIM-Yanai.pdf>

In addition, the technology carrying out the generic object recognition by performing an area-division on the image for each object is described in the following document.

Jamie Shotton etc, “Semantic Texton Forests for Image Categorization and Segmentation”, [Search on Heisei 24 July 26], Internet <URL: http://cite seerx.ist.psu.edu/viewdoc/download?doi=10.1.1.145.3036&rep=rep1&type=pdf>

In addition, no limitation is given to the method for calculating the similarity degree between the image of a captured commodity G and commodity images of the registration commodities registered in the commodity characteristic file F4. For example, the similarity degree between the image of the captured commodity G and registration commodities registered in the commodity characteristic file F4 can be calculated as an absolute evaluation or a relative evaluation.

If the similarity degree is calculated as an absolute evaluation, the similarity degree is the directly-exported comparison result of a comparison between the image of the captured commodity G and each registration commodity registered in the commodity characteristic file F4. In addition, if the similarity degree is calculated as a relative evaluation, the similarity degree can be calculated as long as the sum of the similarity degrees between the captured commodity G and each registration commodities registered in the commodity characteristic file F4 is 1.0 (100%).

The commodity candidate prompt section 1616 displays information relating to the registration commodity recognized by the similarity degree determination section 1615 as a candidate on the display device 106 as a commodity candidate. Specifically, the commodity candidate prompt section 1616 reads commodity information of the registration commodities recognized as candidates from the FLU file F1 of the POS terminal 11, and displays on the display device 106 in the descending order of similarity degree.

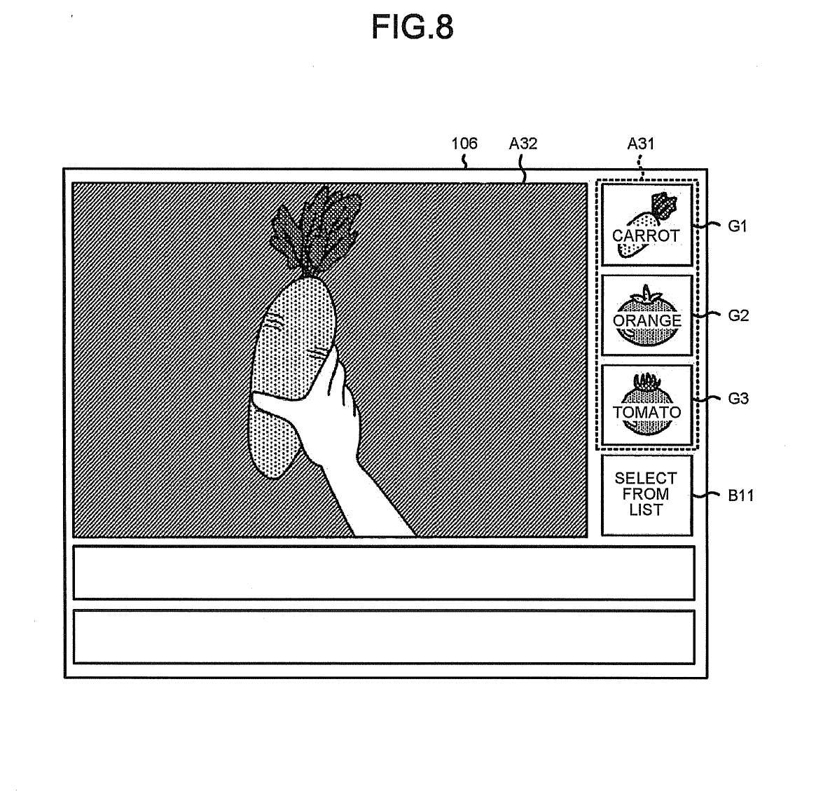

FIG. 8 is a diagram illustrating a display example of commodity candidates. As shown in FIG. 8, in a commodity candidate prompt area A31 on the display screen of the display device 106, the illustration images G1, G2 and G3 contained in the commodity information of commodity candidate are displayed in the descending order of similarity degree of the registration commodity together with the commodity names. The illustration images G1, G2 and G3 can be selected by touching the touch panel 105. Further, a selection button B11 is arranged in the lower part of the commodity candidate prompt area A31 to select a commodity from a commodity list, and the commodity selected from the commodity list is processed as a determined commodity which will be described later. Further, the captured image of the second camera 165 acquired by the image acquisition section 1611 is displayed in an area A32.

Further, three commodity candidates are exemplarily prompted in FIG. 8, however, the method for prompting commodity candidates is not limited to this. For example, a commodity image registered in the commodity characteristic file F4 may be displayed instead of the illustration image. Further, the thermography of the first camera 164 may be displayed in an area A33.

Return to FIG. 7, the input reception section 1617 receives various input operations corresponding to the display of the display device 106 through the touch panel 105 or keyboard 107. For example, the input reception section 1617 receives a selection operation of selecting any one commodity candidate from the illustration images (referring to FIG. 8) of the commodity candidates displayed on the display device 106. The input reception section 1617 receives the commodity candidate of the selected illustration image as a commodity (determined commodity) corresponding to the commodity G captured by the second camera 165.

The information output section 1618 outputs information (e.g. commodity ID or commodity name) representing a determined commodity determined in the way stated above to the POS terminal 11 via the connection interface 175.

Further, the information output section 1618 may output the sales volume input from the touch panel 105 or keyboard 107 in another way together with commodity ID to the POS terminal 11. Further, as information output to the POS terminal 11 by the information output section 1618, the commodity ID read by the information output section 1618 from the PLU file F1 may be directly notified, or a commodity name, an illustration image and the file name of the illustration image capable of specifying a commodity ID may be notified, or a storage position (a storage address in the PLU file F1) of the commodity ID may be notified.

On the other hand, by executing a program, the CPU 61 of the POS terminal 11 can function as a sales registration section (module) 611, which registers the sales of a corresponding commodity based on the commodity ID and sales volume output from the information output section 1618 of the commodity reading apparatus 101. Specifically, the sales registration section 611 carries out a sales registration by recording the notified commodity ID and the commodity category, commodity name, unit price corresponding to the commodity ID in a sales master file together with sales volume with reference to the PLU file F1.

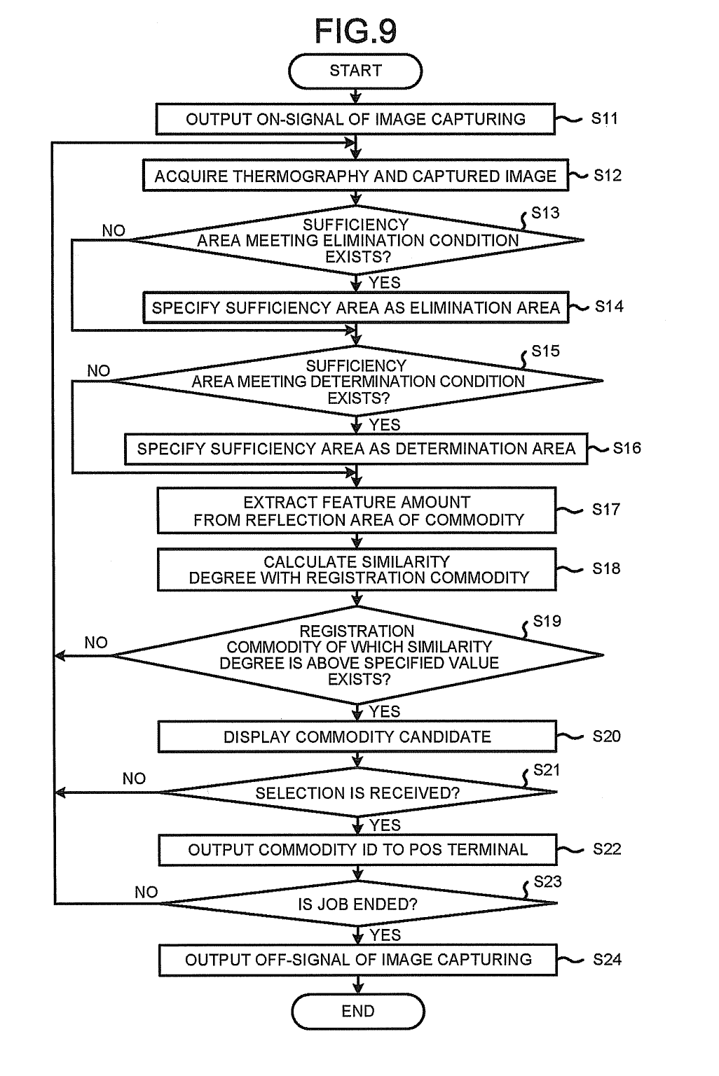

Next, operations of the checkout system 1 are described. Operations of the commodity reading apparatus 101 are described first. FIG. 9 is a flowchart illustrating the procedure of a commodity recognition processing executed by the commodity reading apparatus 101.

As shown in FIG. 9, when a processing is started in response to the start of the commodity registration by the POS terminal 11, the image acquisition section 1611 outputs an ON-signal of image capturing to the first camera 164 and the second camera 165 to activate the first camera 164 and the second camera 165 to start an image capturing operation (ACT S11). Next, the image acquisition section 1611 acquires the thermography and the captured image which are captured by the first camera 164 and the second camera 165 and stored in the RAM 163 (ACT S12).

The elimination area specification section 1612 determines whether or not the sufficiency area meeting the elimination condition exists in the thermography acquired by the image acquisition section 1611 based on the elimination condition stored in the elimination area specification file F2 of the POS terminal 11 (ACT S13). Further, if the elimination condition is defined in the elimination area specification file F2 based on the captured image, the elimination condition is determined according to the captured image acquired by the image acquisition section 1611.

In ACT S13, if it is determined that the sufficiency area exists (YES in ACT S13), the elimination area specification section 1612 specifies the sufficiency area as the elimination area (ACT S14), and then the flow proceeds to ACT S15. Further, if it is determined that the sufficiency area doesn't exist (NO in ACT S13), the flow proceeds to ACT S15 directly.

The determination area specification section 1613 determines whether or not the sufficiency area meeting the determination condition exists in the thermography (or in the captured image) acquired by the image acquisition section 1611 based on the determination condition stored in the determination area specification file F3 of the POS terminal 11 (ACT S15).

In ACT S15, if it is determined that the sufficiency area exists (YES in ACT S15), the determination area specification section 1613 specifies the sufficiency area as the determination area (ACT S16), and then the flow proceeds to ACT S17. Further, if it is determined that the sufficiency area doesn't exist (NO in ACT S15), the flow proceeds to ACT S17 directly.

Next, the feature amount extraction section 1614 extracts feature amount from the reflection area of the commodity G in the captured image acquired in ACT S12 based on the elimination area and the determination area specified in ACT S14 and ACT S16 (ACT S17). The similarity degree determination section 1615 calculates the similarity degree between the feature amount extracted in ACT S17 and the feature amount of each registration commodity registered in the commodity characteristic file F4 of the POS terminal 11 (ACT S18). Sequentially, the similarity degree determination section 1615 determines whether or not the registration commodities the similarity degrees are calculated in ACT S18 include a registration commodity of which the similarity degree with the feature amount of the commodity G is above a threshold value (ACT S19).

If it is determined that the registration commodity of which the similarity degree is above a threshold value exists in ACT S19 (YES in ACT S19), the similarity degree determination section 1615 recognizes the registration commodity as a candidate of the commodity G, and then the flow proceeds to ACT S20. Further, if it is determined that the registration commodity of which the similarity degree is above a threshold value doesn't exist (NO in ACT S19), the flow returns to ACT S12 again.

Next, in ACT S20, the commodity candidate prompt section 1616 displays information relating to the registration commodity recognized in ACT S19 as a candidate on the display device 106 as a commodity candidate (ACT S20).

The input reception section 1617 determines whether or not a selection on a commodity candidate displayed on the display device 106 is received through the touch panel 105 or keyboard 107 (ACT S21). Herein, if the selection operation is received (YES in ACT S21), the input reception section 1617 receives the selected commodity candidate as a determined commodity corresponding to the commodity G captured by the second camera 165, then, the flow proceeds to ACT S22. On the other hand, if no selection is received (NO in ACT S21), the flow returns to ACT S12 again.

Sequentially, the information output section 1618 outputs information such as a commodity ID and the like representing the determined commodity selected in ACT S21 to the POS terminal 11 via the connection interface 175 (ACT S22), and then the flow proceeds to ACT S23.

Herein, if a sales volume is input through the touch panel 105 or the keyboard 107 in another way, the sales volume of the determined commodity is also output to the POS terminal 11 together with the information representing the determined commodity in ACT S22. In addition, if no sales volume is input, a sales volume ‘1’ may be output as a default value.

In ACT S23, the CPU 161 determines whether or not a job is ended based on a commodity registration ending notice sent from the POS terminal 11 (ACT S23). Herein, if the job is to be continued (NO in ACT S23), the CPU 161 returns to ACT S12 to continue the processing. On the other hand, if the job is ended (YES in ACT S23), the image acquisition section 1611 outputs an OFF-signal of image capturing to the second camera 165 to end the image capturing of the second camera 165 (ACT S24), then the processing is ended.

Further, ACTs S15-S16 are executed after ACTs S13-S14 in the processing above, however, the present invention is not limited to this, ACTs S13-S14 may be executed after or in synchronization with ACTs S15-S16. Further, if the registration commodity of which the similarity degree is above a threshold value doesn't exist, the content indicating that similar registration commodity doesn't exist is displayed on the display device 106 so that the customer is prompted to make a selection from the commodity list.

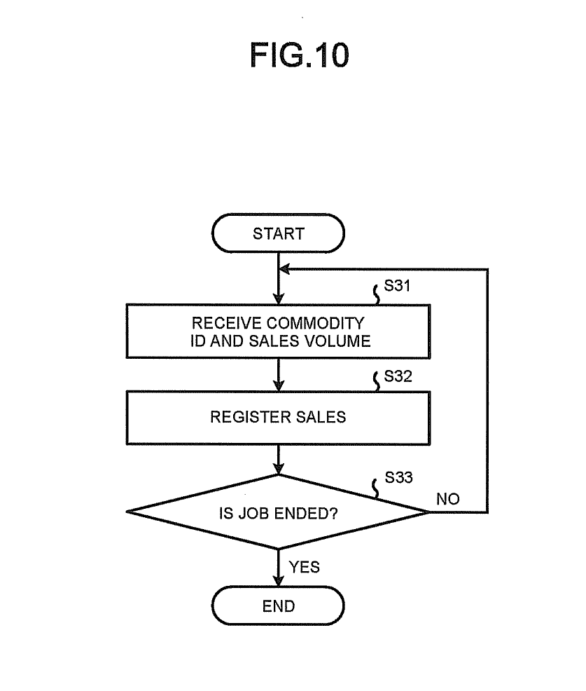

Next, processing operations of the POS terminal 11 are described. FIG. 10 is a flowchart illustrating the procedure of a sales registration processing executed by the POS terminal 11.

First, when the processing is started in responses to the start of the commodity registration according to an operation instruction from the keyboard 22, the CPU 61 receives the commodity ID of a determined commodity output by the commodity reading apparatus 101 in ACT 323 of FIG. 9 and the sales volume of the determined commodity (ACT 331). Next, the sales registration section 611 reads a commodity category or unit price and the like from the PLU file F1 based on the commodity ID and sales volume received in ACT 331 and registers the sales of the commodity G read by the commodity reading apparatus 101 in a sales master file (ACT 332).

Sequentially, the CPU 61 determines whether or not a job is ended based on the ending of the sales registration according to the operation instruction of the keyboard 22 (ACT S33). If the job is to be continued (NO in ACT S33), the CPU 61 returns to ACT 331 to continue the processing. If the job is ended (YES in ACT 333), the CPU 61 ends the processing.

As stated above, in accordance with the present embodiment, the elimination area and the determination area can be specified by using the thermography captured by the first camera 164, therefore, the reflection area of a hand and the like which is a hindrance to the recognition of the commodity G and the area in which the commodity G subjected to the recognition exists can be distinguished easily. Thereby, the feature amount can be extracted efficiently and the precision can be improved, therefore the recognition rate of the commodity G can be increased.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, it is assumed in the embodiment above that a PLU file F1, an elimination area specification file F2, a determination area specification file F3 and a commodity characteristic file F4 are included in the POS terminal 11, however, the present invention is not limited to this, all or part of the PLU file F1, the elimination area specification file F2, the determination area specification file F3 and the commodity characteristic file F4 may be included in the commodity reading apparatus 101.

Further, it is set in the embodiment above that a commodity candidate is recognized in the commodity reading apparatus 101, however, all or part of the functional sections of the commodity reading apparatus 101 may be included by the POS terminal 11. For example, the POS terminal 11 may comprise an elimination area specification section 1612, a determination area specification section 1613, a feature amount extraction section 1614 and a similarity degree determination section 1615, and the commodity reading apparatus 101 may comprise an image acquisition section 1611, a commodity candidate prompt section 1616, an input reception section 1617 and an information output section 1618. In this case, it may be set that the captured image acquired by the image acquisition section 1611 may be sent to the POS terminal 11 at the side of the commodity reading apparatus 101, a result of a recognized commodity (registration commodity) is received at the side of the POS terminal 11, and the commodity candidate prompt section 1616 prompts the received result as a commodity candidate. Further, if the functional sections of the commodity reading apparatus 101 are all included by the POS terminal 11, the commodity reading apparatus 101 functions as an image capturing apparatus, and a commodity candidate is displayed and selected in the POS terminal 11 based on the captured image sent from the commodity reading apparatus 101.

Further, the aforementioned embodiment is applied to the commodity reading apparatus 101 of the checkout system 1 including the POS terminal 11 and the commodity reading apparatus 101, however, the present invention is not limited to this, embodiments of the present invention may also be applied to an apparatus comprising the functions of the POS terminal 11 and the commodity reading apparatus 101 or a checkout system formed by, for example, connecting the commodity reading apparatus 101 with the POS terminal 11 shown in FIG. 1 in a wired or wireless manner. A self-checkout apparatus (hereinafter referred to as a self POS for short) arranged and used in a store such as a supermarket can be listed as an apparatus comprising the functions of the POS terminal 11 and the commodity reading apparatus 101.

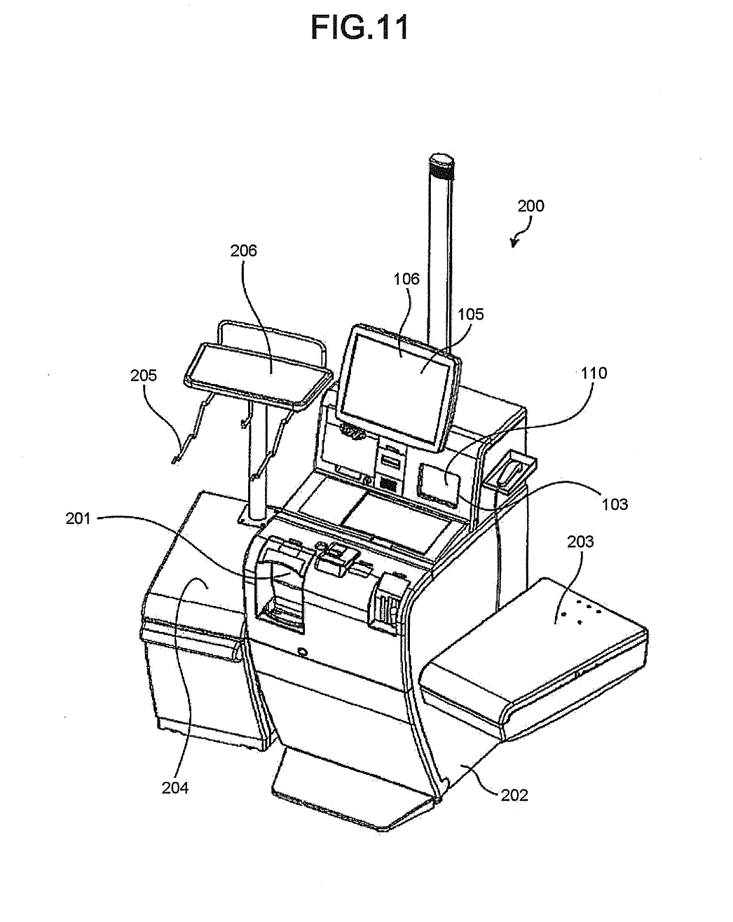

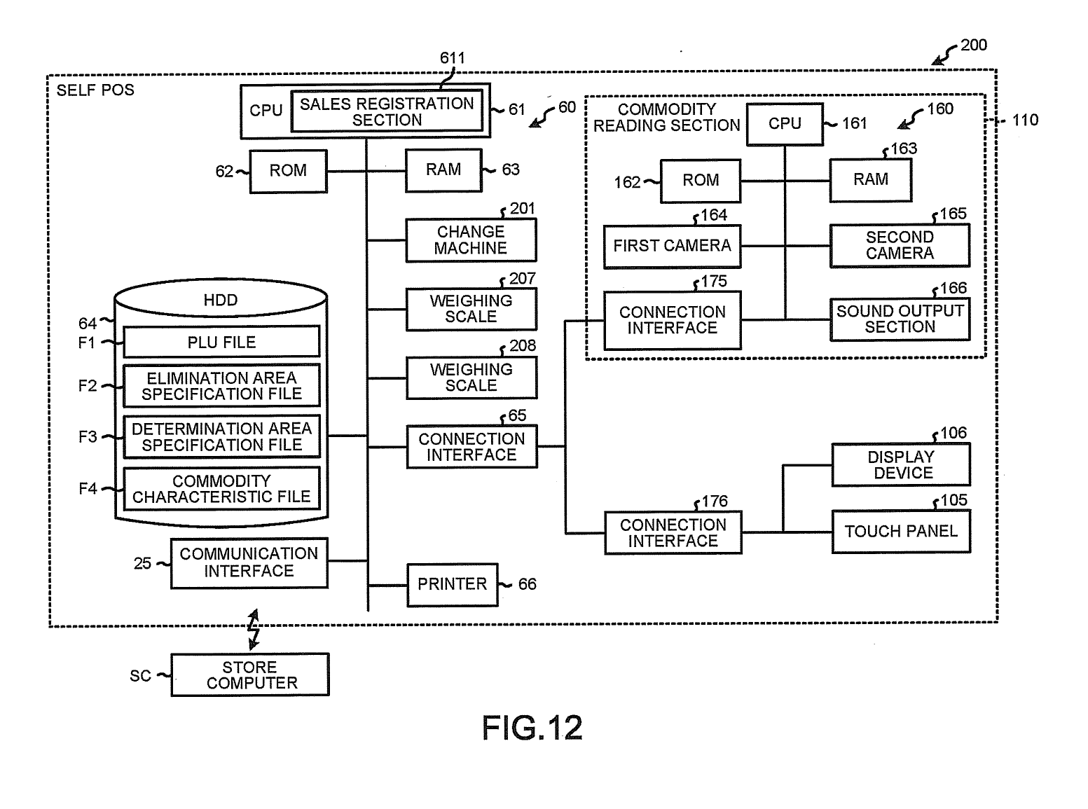

Herein, FIG. 11 is a perspective view illustrating the external configurations of a self POS 200, and FIG. 12 is a block diagram illustrating the hardware arrangement of the self POS 200. Further, the same configurations shown in FIG. 1 and FIG. 2 are denoted with the same signs and are therefore not described repeatedly.

As shown in FIG. 11 and FIG. 12, the main body 202 of the self POS 200 comprises a display device 106 having a touch panel 105 on the surface thereof and a commodity reading section 110 which reads a commodity image to recognize (detect) the category of a commodity G.

The display device 106 may be, for example, a liquid crystal display. A guidance screen for providing the customer a guidance for the operation of the self POS 200, various input screens, a registration screen for displaying the commodity information read by the commodity reading section 110 and a settlement screen on which a total amount, a prepayment amount and a change amount as well as a payment method selection are displayed on the display device 106.

The commodity reading section 110 is a section which acquires a thermography and a captured image of the commodity G using the first camera 164 and the second camera 165 when the customer holds the commodity over the reading window 103 of the commodity reading section 110.

Further, a commodity placing table 203 for placing the unsettled commodity in a shopping basket is arranged on the right side of the main body 202, and on the left side of the main body 202, a commodity placing table 204 for placing the settled commodity, a bag hook 205 for hooking a bag for placing the settled commodities and a temporary placing table 206 for placing the settled commodities temporarily before the settled commodities are placed into a bag are arranged. The commodity placing tables 203 and 204 are provided with weighing scales 207 and 208 respectively, and are therefore capable of confirming whether or not the weight of commodities is the same before and after a settlement.

Further, a change machine 201 for inputting bill for settlement and outputting bill as change is arranged in the main body 202 of the self POS 200.

In the case where the self POS 200 having such configurations is applied to embodiments of the present invention, the self POS 200 functions as an information processing apparatus. Further, the apparatus comprising the functions of the POS terminal 11 and the commodity reading apparatus 101 may be an apparatus provided with no weighing scales 207 and 208, but not limited to the self POS 200 having the configurations above.

Further, in the embodiment above, the programs executed by each apparatus are pre-incorporated in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via an LAN or the Internet.

In addition, the programs executed by each apparatus described in the embodiments above may be stored in a computer connected with a network such as the Internet to be provided through a network download or provided or distributed via a network such as the Internet.

Alternatively, the programs mentioned in the embodiments above may be incorporated in a portable information terminal such as a mobile phone having a communication function, a smart phone, a PDA (Person Digital Assistant) and the like to realize the functions of the programs.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
an area specification module configured to specify a sufficiency area meeting a specified temperature condition from a thermography representing the temperature distribution in an image capturing area;
an extraction module configured to extract feature amount from a specified area in a captured image of the image capturing area based on the sufficiency area specified by the area specification module; and
an object recognition module configured to recognize an object contained in the captured image module the feature amount extracted by the extraction module.

2. The information processing apparatus according to claim 1, wherein
the area specification unit specifies an area of which at least one of a shape or an arrangement position of an area meeting the temperature condition meets a specified condition as a sufficiency area.

3. The information processing apparatus according to claim 1, wherein
the area specification unit specifies the sufficiency area as an elimination area eliminated from an object subjected to feature amount extraction;
the extraction unit extracts the feature amount from an area in which the elimination area is eliminated in the captured image.

4. The information processing apparatus according to any one of claim 1, wherein
the area specification unit specifies the sufficiency area as a determination area subjected to feature amount extraction.
the extraction unit extracts the feature amount from the determination area in the captured image.

5. The information processing apparatus according to claim 4, wherein
the area specification unit specifies the determination area accompanying the elimination area specified from the thermography.

6. An information processing method, comprising:
specifying a sufficiency area meeting a specified temperature condition from a thermography representing the temperature distribution in an image capturing area;
extracting feature amount from a specified area in a captured image of the image capturing area based on the sufficiency area specified; and
recognizing an object contained in the captured image using the feature amount extracted.

7. The information processing method according to claim 6, wherein
specifying an area of which at least one of a shape or an arrangement position of an area meeting the temperature condition meets a specified condition as a sufficiency area.

8. The information processing method according to claim 6, wherein
specifying the sufficiency area as an elimination area eliminated from an object subjected to feature amount extraction;
extracting the feature amount from an area in which the elimination area is eliminated in the captured image.

9. The information processing method according to any one of claim 6, wherein
specifying the sufficiency area as a determination area subjected to feature amount extraction.
extracting the feature amount from the determination area in the captured image.

10. The information processing method according to claim 9, wherein
specifying the determination area accompanying the elimination area specified from the thermography.
